(19) United States
(12) Patent Application Publication
(10) Pub. No.: US 2016/0173834 A1
(43) Pub. Date: Jun. 16, 2016

(54) PLASMONIC POLARIZATION-SENSITIVE IMAGE SENSOR

(71) Applicant: Palo Alto Research Center Incorporated, Palo Alto, CA (US)

(72) Inventors: Julie Bert, East Palo Alto, CA (US); Robert A. Street, Palo Alto, CA (US); Sourobh Raychaudhuri, Mountain View, CA (US)

(21) Appl. No.: 14/570,962

(22) Filed: Dec. 15, 2014

(51) Int. Cl. H04N 9/04; G02B 5/30; H04N 5/335

(52) U.S. Cl. CPC H04N 9/045; H04N 5/335; G02B 5/30

(57) ABSTRACT

A polarization-sensitive imager, include a polarization filter, the polarization filter including a first region and a second region, a pixel array of light sensors coupled to the polarization filter, the pixel array of light sensors including a first region associated with the first region of the polarization filter and a second region associated with the second region of the polarization filter, each region of the pixel array of light sensors configured to output a signal based on an amount of light illuminated on the region and a processor configured to simultaneously determine an intensity image and a polarization image by taking a sum and difference of the signal of the first region of the pixel array of lights sensors and the signal of the second region of the pixel array of light sensors.

### TECHNICAL FIELD

The presently disclosed embodiments are directed to image sensors that include polarization filters.

### BACKGROUND

Image sensor arrays gain in utility when they simultaneously image a wide range of properties of incident light. Polarization, however, is not commonly captured by an image array of a camera. But pixel-level polarization measurements may provide important additional information about the object or scene that is imaged by the camera.

### BRIEF DESCRIPTION OF THE DRAWINGS

FIG. 1 shows a block diagram of an image sensor according to some embodiments of the disclosed technology.

FIG. 2 shows a block diagram of an image sensor according to other embodiments of the disclosed technology.

FIG. 3 shows a block diagram of an image sensor according to other embodiments of the disclosed technology.

FIG. 4 shows a block diagram of an image sensor according to other embodiments of the disclosed technology.

FIG. 5 shows a diagram of a sample polarization filter.

FIG. 6 shows the preferred polarization angles of the four polarization filters of FIG. 4.

FIG. 7 shows a theory plot of the spectrum of transmitted light through the polarization filters for difference incident polarizations.

FIG. 8 shows a full 2D polarization imaging array by tiling the filter group shown in FIG. 6 across an entire pixel image array.

### SUMMARY

According to aspects illustrated herein, there is provided a polarization-sensitive imager, including a patterned polarization filter, the polarization filter including a first region and a second region where each region is sensitive to a different polarization of light, a pixel array of light sensors aligned with the patterned polarization filter, the pixel array of light sensors including a first region associated with the first region of the polarization filter and a second region associated with the second region of the polarization filter, each region of the pixel array of light sensors configured to output a signal based on an amount of light illuminated on the region and a processor configured to simultaneously determine an intensity image and a polarization image by taking a sum and difference of the signal of the first region of the pixel array of lights sensors and the signal of the second region of the pixel array of light sensors.

Also according to aspects illustrated herein, there is also provided a system, including a polarization-sensitive imager and a processor. The polarization-sensitive imager includes a patterned polarization filter, the polarization filter including a first region and a second region where each region is sensitive to a different polarization of light, and a pixel array of light sensors aligned with the polarization filter, the pixel array of light sensors including a first region associated with the first region of the polarization filter and a second region associated with the second region of the polarization filter, each region of the pixel array of light sensors configured to output a signal based on an amount of light illuminated on the region. The processor is configured to simultaneously determine an intensity image and a polarization image by taking a sum and difference of the signal of the first region of the pixel array of lights sensors and the signal of the second region of the pixel array of light sensors.

### DETAILED DESCRIPTION OF THE EMBODIMENTS

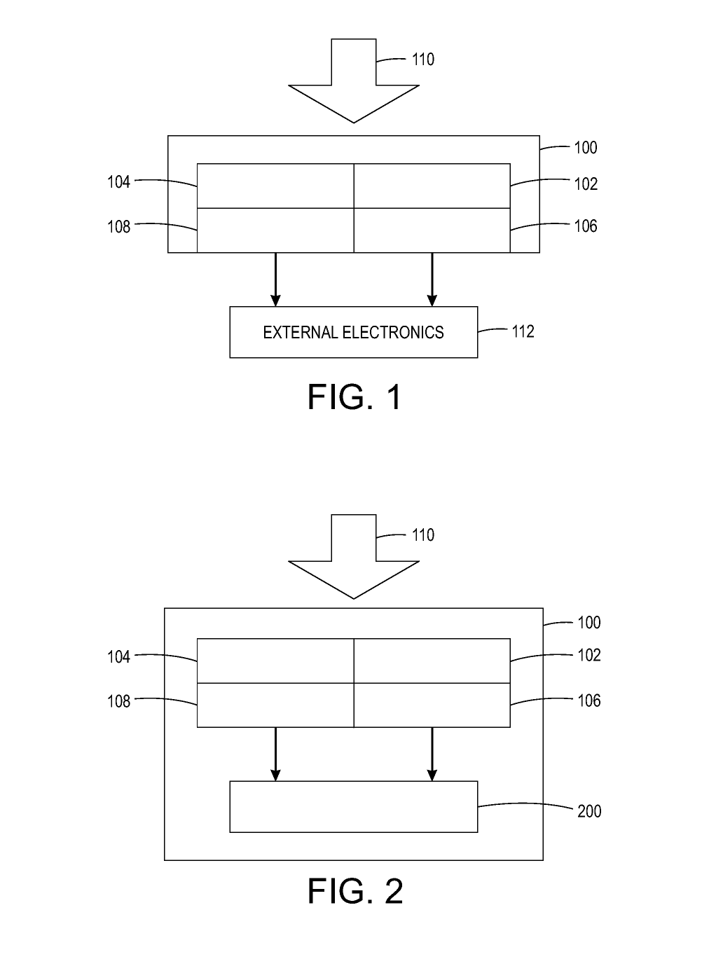

FIG. 1 shows a polarization-sensitive imager 100 with a polarization filter having a first region 102 and a second region 104. The polarization-sensitive imager 100 also includes a pixel array of light sensors including a first region 106 and a second region 108. The polarization filter may be, for example, a plasmonic optical filter. However, any known type of polarization filter may be used. The polarization filter may be placed close to the pixel array, within the depth of field of the imaging optics. However, the polarization filter may also be placed away from the pixel array, at a secondary focal point of the imaging optics and projected onto the pixel array. In such a situation, the image must be re-focused onto the pixel array for the imager 100 to properly capture the image. Conventional imaging optics may be used to form an image of a scene onto the pixel array.

The pixel array may be a two-dimensional pixel array. The pixel array may also be a linear array within which a two-dimensional image is obtained by scanning either the object or scene being captured or scanning the linear array itself. Any suitable technology for the pixel array can be used, such as, for example, silicon complementary metal-oxide-semiconductors (CMOS), charge coupled device (CCD) technologies, amorphous silicon active matrix arrays or microbolometer arrays.

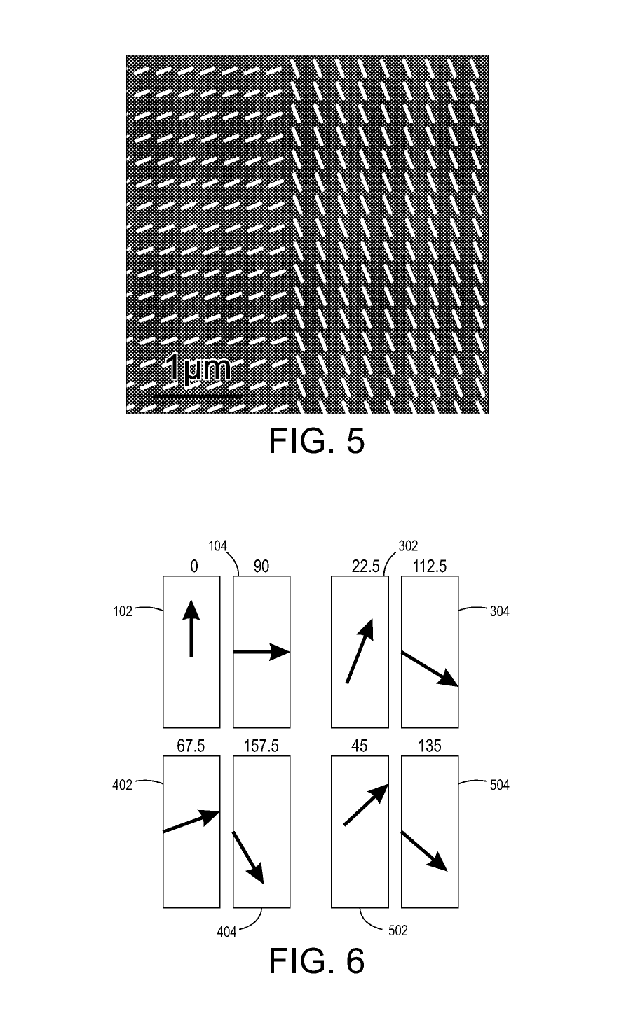

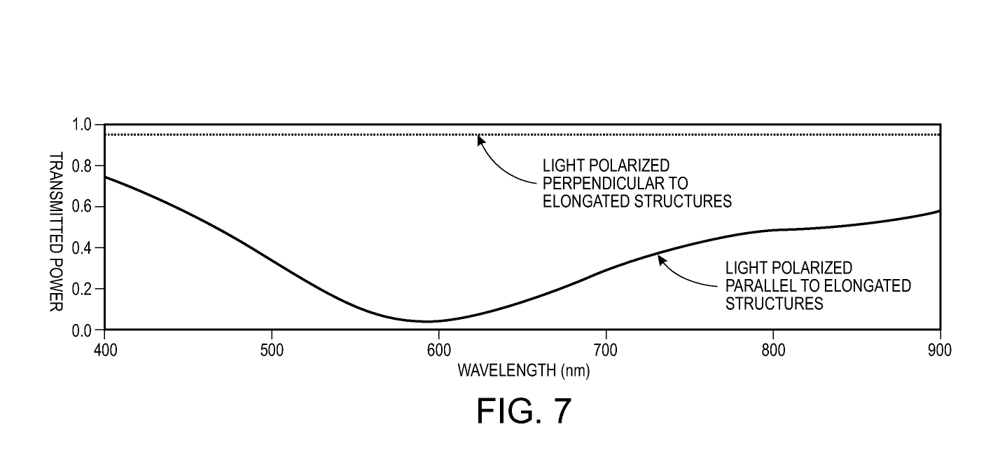

In one embodiment, the polarization filter is made by depositing a thin film of metal or semiconductor and patterning it to form a suitably-designed array of geometric features. The polarization filter is composed of an oriented array of elongated features with size comparable to the wavelength of light. An example polarization filter is shown in FIG. 5. FIG. 7 shows an example of a spectral response of a polarization filter. The angular orientation of the features determines the intensity of transmission as a function of the polarization angle of the light. The size of the features, their periodicity and the specific material used to make the filter determine the transmission of the filter as a function of wavelength. The transmission and polarization of the filter can be calculated by solving the wave equations by standard means. Typically, the structures have a pitch of 200-300 nm for visible light, but this dimension can be larger or smaller for filters in other regions of the electromagnetic spectrum such as ultra-violet, infrared or microwave, for example.

The pair of polarization regions 102 and 104 in FIGS. 1-4 and 7 should be designed so the maximum transmission for polarized light in each region is shifted by 90 degrees, as shown in FIG. 6. Linearly polarized light aligned with one region will have high optical transmission through that region and low optical transmission through the other region. To be sensitive to more polarization angles, multiple orientations of these paired polarization regions may be provided as shown in FIG. 6. The area of each polarization filter should match the underlying pixel area of the imaging sensor so that the pattern of the polarization filter is commensurate with the pixels of the array. An area of about 1×1 micron or larger may be used for each pair of polarization regions to correspond with the pixel pitch of current visible light array image sensors. A region of the polarization filter may be aligned with a single imager pixel or with a block of pixels.

The imager 100 may include pixelated wavelength filters as well (not shown). These could be used as color filters for visible light image sensors. The design of the polarization filter may be optimized for the specific wavelength range of any pixel array imager in the electromagnetic spectrum, using known techniques.

As mentioned above, FIG. 7 shows the spectrum of transmitted light through a polarization filter for different incident polarizations. Light that is polarized parallel to the elongated structures is strongly reflected throughout the visible spectrum, with a maximum reflection near 600 nm. However, light polarized perpendicular to the elongated structures is essentially unaffected by the polarization filter.

The general design and fabrication of polarization filters are known. Fabrication of the polarization filters for visible light applications are typically done using e-beam lithography on a glass substrate, using known techniques. Photolithography techniques used for silicon integrated circuits may also be used and have the capability of patterning the desired features, which typically have a size in the range of 50-500 nm. Larger structures can be used for the polarization filters in the infrared and microwave regions.

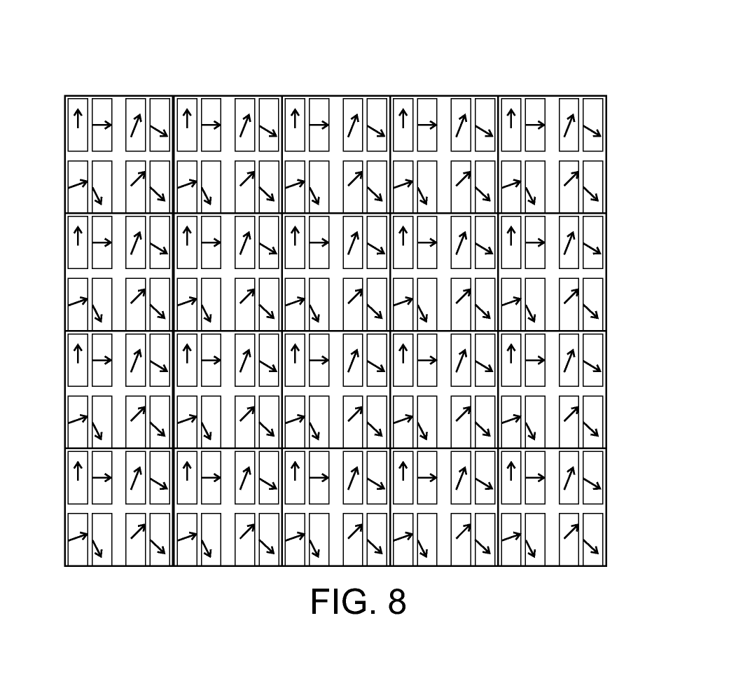

In one embodiment, the polarization filter further comprises a plurality of polarization filters, each polarization filter including a first region and a second region. An example is shown in FIG. 8. In this case each polarization filter region must be at least as large as a single pixel of the underlying image sensor. The polarization filter regions may be larger incorporating several underlying imaging pixels.

The polarization filter may be fabricated on a separate substrate or directly on the image sensor array. If the polarization filter is fabricated on a separate substrate, the polarization filter is accurately aligned to the image sensor array such that the patterned regions of the polarization filter are located within about 10% of the linear dimension of the pixels of the image sensor array. This may be done by providing suitable alignment marks outside the imaging area on both the image pixel array and the polarization filter, which can be done as part of the fabrication process without requiring additional steps. Mechanical adjustment while viewing the alignment marks may then position the filter.

However, if the polarization filter is integrated with the image pixel array, alignment may be achieved in the usual way for photolithographic patterning of multiple layers. Since the performance of the filter depends on the optical properties of the underlying layers, the calculation of the filter pattern needs to be specific to the method of integration and the detail of the materials involved.

The polarization-sensitive imager 100 of FIG. 1 can provide both a normal image, i.e. a total light intensity, and a polarization image by taking the sum and difference, respectively, of the light intensity incident on the two adjacent rectangular regions 106 and 108 of the pixel array, as shown in FIG. 1. Each adjacent rectangular region 106 and 108 is associated with one of two regions 102 and 104 of the polarization filter. The sum of the light intensity incident on the two adjacent rectangular regions 106 and 108 of the pixel array provides the normal image because the two adjacent regions 106 and 108 are behind polarization regions 102 and 104 that are 90 degree out of phase. The difference image provides the polarization of the incident light. If the difference of the light intensity incident is large the polarization of the light is closely aligned with one of the two regions. If the difference is small then the polarization is poorly aligned with both regions and is in between the regions. Adding more pairs of polarization regions to the polarization filter increases the accuracy for determining the exact polarization angle of the incident light.

Light is illuminated in the direction of arrow 110 toward the polarization-sensitive imager 100. Each adjacent rectangular region 106 and 108 of the pixel image sensor outputs a signal based on the amount of light transmitted through the regions 102 and 104 of the polarization filter. The output signal is generally a voltage or an electronic charge with a magnitude proportional to the measured light intensity. The external electronics usually consist of an analog to digital converter to give a digitized signal corresponding to the light intensity. The sum and difference values can then be calculated using a conventional digital computer.

The electronics, however, need not be external to the polarization-sensitive imager 100. The electronics may also be located within the polarization-sensitive imager 100. As shown in FIG. 2, the electronics 200 may be placed within the polarization-sensitive imager 100. As discussed above with respect to FIG. 1, the signals from each region of the pixel image array 106 and 108 are sent to the electronics 200 to determine the sum and difference values between the two regions 106 and 108 when light 110 is projected on them through the polarization regions 102 and 104.

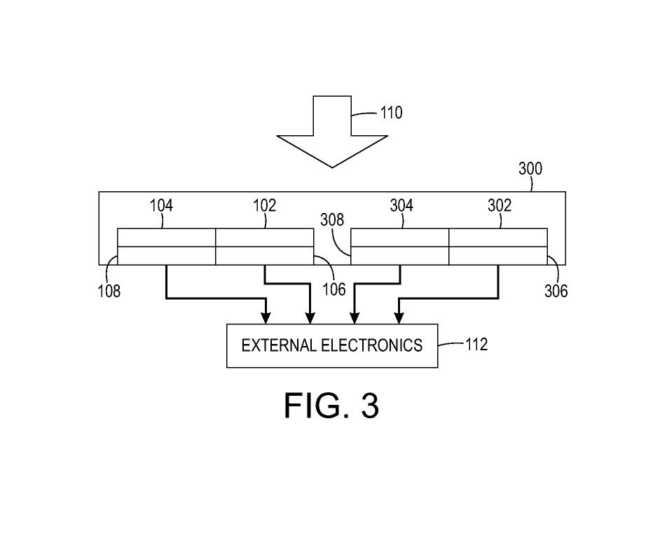

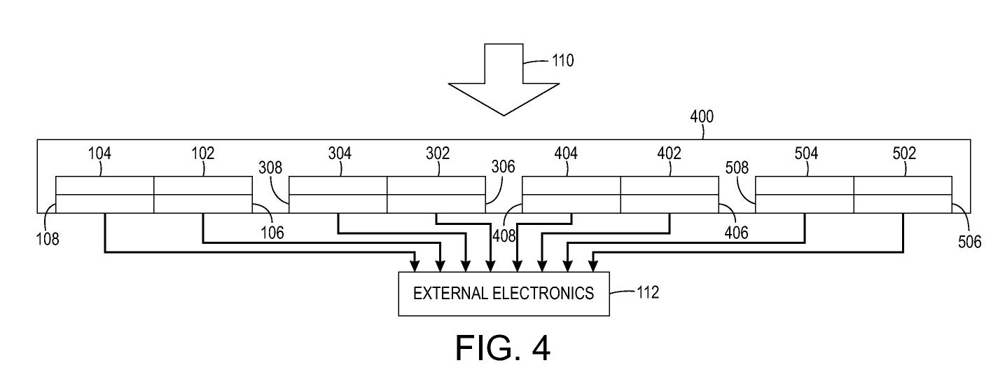

Embodiments of the polarization-sensitive imager shown in FIGS. 3, 4 & 7 includes multiple pairs of polarization or wavelength sensitive regions. The polarization-sensitive imager 300 of FIG. 3 includes two pairs of regions of polarization filter over corresponding pixel imager array. Although the pair of regions 106, 108 and 306, 308 are shown as separated, the regions will usually be included on a single pixelated imaging array. The polarization-sensitive imager 300 also includes polarization filter pairs of regions 102, 104 and 302, 304. A signal is sent to external electronics 112 from each of the regions 106, 108, 306 and 308 to read the intensity of light from the illumination 110. In this case the external electronics would also apply a demosaicing algorithm to reconstruct an image from the set of polarization filters. That is, the electronics may reassemble an intensity image and polarization image for a captured scene. Although not shown, the electronics 112 can also be located within the imager 300, as discussed above with respect FIG. 2.

The first pair of regions 102 and 104 of the polarization filters may include filters with a 90 degree rotated polarization at angles of 0 and 90 deg. A single pair of polarization filters, however, may not uniquely define the polarization angle. Accordingly, the second pair of regions of the polarization filter 302 and 304 preferably has a 90 degree rotated polarization at angles of 45 and 115 deg. If the incident light is polarized but in a direction that first pair of pixel array regions 106 and 108 gives zero intensity difference, then the second pair of pixel array regions 306 and 308 will give a maximum intensity difference.

FIG. 4 shows an image sensor with four pairs of polarization filter regions 102, 104, 302, 304, 402, 404, 502, and 504. The image sensor also includes four pairs of pixel array regions 106, 108, 306, 308, 406, 408, 506, and 508. As with FIGS. 1-3, the pixel array regions 106, 108, 306, 308, 406, 408, 506, and 508 are connected to external electronics 112 to read the signals from each of the regions when light is illuminated no the polarization-sensitive imager 400. As with FIGS. 2 and 3 above, the electronics 112 can also be located within the polarization-sensitive imager 400 itself.

FIG. 6 shows a more complete set of possible polarization angles for each of the polarization filter regions 102, 104, 302, 304, 404, 404, 502, and 504. Each of the polarization angles are separated by 22.5 degrees; however, many alternative designs can be used with different polarization angles. Increasing the number of pairs of polarization regions used with different polarization angles provides more accurate polarization data.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A polarization-sensitive imager, comprising:
a polarization filter, the polarization filter including a first region and a second region;
a pixel array of light sensors aligned with the polarization filter, the pixel array of light sensors including a first region associated with the first region of the polarization filter and a second region associated with the second region of the polarization filter, each region of the pixel array of light sensors configured to output a signal based on an amount of light illuminated on the region; and
a processor configured to determine a polarization image by taking a difference of the signal of the first region of the pixel array of lights sensors and the signal of the second region of the pixel array of light sensors.

2. The polarization-sensitive imager of claim 1, wherein the polarization filter is composed of an oriented array of elongated features with size comparable to the wavelength of light.

3. The polarization-sensitive image of claim 1, wherein the polarization filter is deposited on top of the pixel array of light sensors.

4. The polarization-sensitive imager of claim 1, wherein the polarization filter is fabricated on a separate substrate and mechanically aligned with the pixel array of light sensors.

5. The polarization-sensitive imager of claim 1, wherein the polarization filter is directly integrated into the pixel array of light sensors to change the behavior of the light sensing elements.

6. The polarization-sensitive imager of claim 1, wherein the polarization filter is separated from the image sensor and uses optics to focus the polarization image onto the pixel image sensor.

7. The polarization-sensitive imager of claim 1, wherein the processor is further configured to calculate the sum and difference of pixels in the imaging array associated with regions of the polarization filter, and reassemble an intensity image and a polarization image for a scene.

8. The polarization-sensitive imager of claim 1, wherein the first region and the second region of the polarization filter are optimally sensitive to polarizations that are separated by 90 degrees.

9. The polarization-sensitive imager of claim 1, further comprising a plurality of polarization filters, each polarization filter including a first region and a second region.

10. A system to simultaneously image the light intensity and polarization of a scene, comprising:
a polarization-sensitive imager, the polarization-sensitive imager including:
a polarization filter, the polarization filter including a first region and a second region; and
a pixel array of light sensors coupled to the polarization filter, the pixel array of light sensors including a first region associated with the first region of the polarization filter and a second region associated with the second region of the polarization filter, each region of the pixel array of light sensors configured to output a signal based on an amount of light illuminated on the region; and
a processor configured to determine a polarization image by taking a sum and difference of the signal of the first region of the pixel array of lights sensors and the signal of the second region of the pixel array of light sensors.

11. The system of claim 11, wherein the polarization filter is composed of an oriented array of elongated features with a size comparable to the wavelength of light.

12. The system of claim 11, wherein the polarization filter is deposited on top of the pixel array of light sensors.

13. The system of claim 11, wherein the polarization filter is fabricated on a separate substrate and mechanically aligned with the pixel array of light sensors.

14. The system of claim 11, wherein the polarization filter is directly integrated into the pixel array of light sensors to change the behavior of the light sensing elements.

15. The system of claim 11, wherein the polarization filter is separated from the image sensor and uses optics to focus the polarization image onto the pixel image sensor.

16. The system of claim 11, wherein the processor is further configured to calculate the sum and difference of pixels in the imaging array associated with regions of the polarization filter and reassemble an intensity image and a polarization image for a scene.

17. The system of claim 11, wherein the first region and the second region of the polarization filter are optimally sensitive to polarizations that are separated by 90 degrees.

18. The system of claim 11, wherein the polarization-sensitive imager further includes a plurality of polarization filters, each polarization filter including a first region and a second region.
